(19) United States
(12) Patent Application Publication
(10) Pub. No.: US 2024/0346451 A1
(43) Pub. Date: Oct. 17, 2024

(54) Service Provider Hiring System and Method Thereof

(71) Applicant: Michael Peacock, Eagle Point, OR (US)

(72) Inventor: Michael Peacock, Eagle Point, OR (US)

(21) Appl. No.: 18/401,753

(22) Filed: Jan. 2, 2024

Related U.S. Application Data
(60) Provisional application No. 63/496,484, filed on Apr. 17, 2023.

(51) Int. Cl. G06Q 10/1053; G06Q 50/47

(52) U.S. Cl. CPC G06Q 10/1053; G06Q 50/47

(57) ABSTRACT

A system and method for hiring helpers/service providers for different jobs, gigs, work tasks, and errands. The system is configured to register customers/recipients and helpers/service providers. The system and method can display services for selection by a recipient or user and automatically recommend and/or select a service provider for fulfilling the service. The service cost can be fixed or can be adjusted by the customer for price negotiation. In some embodiments, the system can be an extension of a ride-hailing service platform wherein a ride-hailing provider can register as a gig or service provider or can earn a commission by driving a service provider to a service location.

### CROSS-REFERENCE TO RELATED APPLICATION

The present application claims priority to, and the benefit of, U.S. Provisional Application No. 63/496,484, which was filed on Apr. 17, 2023 and is incorporated herein by reference in its entirety.

### FIELD OF THE INVENTION

The present invention relates generally to the field of customer and helper matching systems. More specifically, the present invention relates to a novel system accessible using an application or website that enables users to hire and pay helpers to help with jobs and errands. The platform hosts gig opportunities ranging from manual labor to running errands, and more which can be requested by customers and provided by helpers. The system can be a standalone system or can be an extension of any service provider system such as a ride-hailing service. Accordingly, the present disclosure makes specific reference thereto. Nonetheless, it is to be appreciated that aspects of the present invention are also equally applicable to others like applications, devices, and methods of manufacture.

### BACKGROUND

By way of background, currently, the need for efficient and personalized assistance across various tasks and errands has become increasingly pronounced. Traditional service platforms strive to address these needs; however, they often fall short in delivering a truly seamless and tailored experience.

Individuals, especially elderly individuals often require help for small work tasks such as cleaning a home and a garden, packing/moving furniture, and more. They need to get assistance from their friends and family which is not always possible and available. Individuals desire a system where they can easily hire help for different services.

Existing service platforms typically offer a fixed set of predefined services, limiting their adaptability to the diverse and evolving requirements of users. This rigidity can result in frustration for customers who may struggle to find the right service provider for their specific needs. Additionally, the process of matching users with service providers can be cumbersome and lacking in precision, leading to suboptimal outcomes and potential dissatisfaction. Furthermore, the integration of real-time geolocation data, a crucial component for optimizing service coordination, is frequently underutilized in current solutions. This underutilization can lead to delays, miscommunications, and missed opportunities for efficient service delivery. Individuals desire an improved system that overcomes problems associated with conventional systems in providing help in small and diverse service requirements.

Therefore, there is a long felt need in the art for an innovative and comprehensive solution that addresses the challenges of connecting users seeking diverse assistance with suitable service providers, streamlining the selection process, and ensuring fair compensation. There is also a long felt need for a platform that seamlessly integrates real-time geospatial insights to enhance service coordination and delivery efficiency. Further, there is a recognized necessity in the art for a user-centric interface that empowers individuals to tailor their service experiences while maintaining transparent and secure payment transactions. Furthermore, a longstanding requirement exists for a system that intelligently recommends service providers based on user preferences, optimizing the matching process. Finally, there is a substantial and enduring need in the art for a platform that establishes a harmonious collaboration between users and service providers, fostering a dynamic ecosystem of assistance and support.

The subject matter disclosed and claimed herein, in one embodiment thereof, comprises a services helper hire system. The system comprising a server system, a plurality of user devices, a software application installed in each user device, a customer database for storing customer profiles, a helper database for storing helper profiles, a service database for storing the services offered by the system, a recommendation module for recommending and selecting one or more service providers for fulfilling a request made by a customer, wherein the price of the service can be automatically selected or manually adjusted by the customer.

In this manner, the service helper hiring system of the present invention accomplishes all of the forgoing objectives and provides users with an improved and user-centric solution that harnesses advanced technology and intelligent algorithms to match users with the most suitable service providers. The system improves the way users seek and receive various forms of assistance and seamlessly connects users with a diverse range of service providers. The platform offers a streamlined and personalized experience, addressing the shortcomings of existing methods for locating and engaging assistance.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a services helper hire server system. The system comprising a server system, a plurality of user devices, a software application installed in each user device, a customer database for storing customer profiles, a helper database for storing helper profiles, a service database for storing the services offered by the system, a recommendation module for recommending and selecting one or more service providers for fulfilling a request made by a customer, wherein the price of the service can be automatically selected or manually adjusted by the customer.

In yet another embodiment, a software application for ordering a service is disclosed. The software application enables a processor to display a list of services, receive a selection of a service from the list of services, receive a selected service provider, and receive details of the selected service provider.

In another aspect of the present invention, a method for facilitating service provisioning is described. The method comprising the steps of receiving a service query from a customer, wherein the service query encapsulates service details for assistance, generating a list of service providers or helpers suitable for fulfilling the service, receiving a selection of a desired service provider or helper from the generated list, initiating an advance payment process by the platform, and sending notifications to both the customer and the selected service provider.

A computer implemented system for providing helper (i.e., service provider) to fulfil a service request from a user is disclosed. The system includes a software application, a server system, a user device, wherein the server system is communicatively coupled to the user device via a communications network, the software application is installed in the user device, the user device facilitates a user to select a service, receive a helper detail using the software application, and wherein the helper and, when needed, an associated ride-hailing driver are paid for the service.

In yet another embodiment, a ride-hailing driver of the system registers as a gig provider and is selected by a user for providing help in a service, wherein the ride-hailing driver performs the service and earns the service cost.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic diagram of the on-demand service assistance system of the present invention in accordance with the disclosed architecture;

FIG. 2A illustrates an exemplary user interface offered by the software application for user authentication within the system in accordance with the disclosed architecture;

FIG. 2B illustrates customer user interface offered by the software application for user authentication within the system in accordance with the disclosed architecture;

FIG. 2C illustrates helper user interface offered by the software application for user authentication within the system in accordance with the disclosed architecture;

FIG. 3A illustrates an exemplary user interface displayed by the software application in accordance with the present embodiment;

FIG. 3B illustrates another user interface displayed by the software application in accordance with the present embodiment;

FIG. 3C illustrates an exemplary interface for enabling a customer to adjust price in accordance with the current embodiment;

FIG. 4 illustrates a flow chart depicting a process of ordering a service by a customer using the service ordering system of the present invention in accordance with the disclosed architecture;

FIG. 5 illustrates a flowchart outlining an alternative operational method within the ride-hailing service helper platform in accordance with an embodiment of the present invention; and

FIG. 6 illustrates a flowchart depicting a process of performing service by a ride-hailing driver registered in the system of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an innovative and comprehensive solution that addresses the challenges of connecting users seeking diverse assistance with suitable service providers, streamlining the selection process, and ensuring fair compensation. There is also a long felt need for a platform that seamlessly integrates real-time geospatial insights to enhance service coordination and delivery efficiency. Further, there is a recognized necessity in the art for a user-centric interface that empowers individuals to tailor their service experiences while maintaining transparent and secure payment transactions. Furthermore, a longstanding requirement exists for a system that intelligently recommends service providers based on user preferences, optimizing the matching process. Finally, there is a substantial and enduring need in the art for a platform that establishes a harmonious between users and service providers, fostering a dynamic ecosystem of assistance and support.

The present invention, in one exemplary embodiment, is a method for facilitating service provisioning of a user. The method comprising the steps of receiving a service query from a customer, wherein the service query encapsulates service details for assistance, generating a list of service providers or helpers suitable for fulfilling the service, receiving a selection of a desired service provider or helper from the generated list, initiating an advance payment process by the platform, and sending notifications to both the customer and the selected service provider.

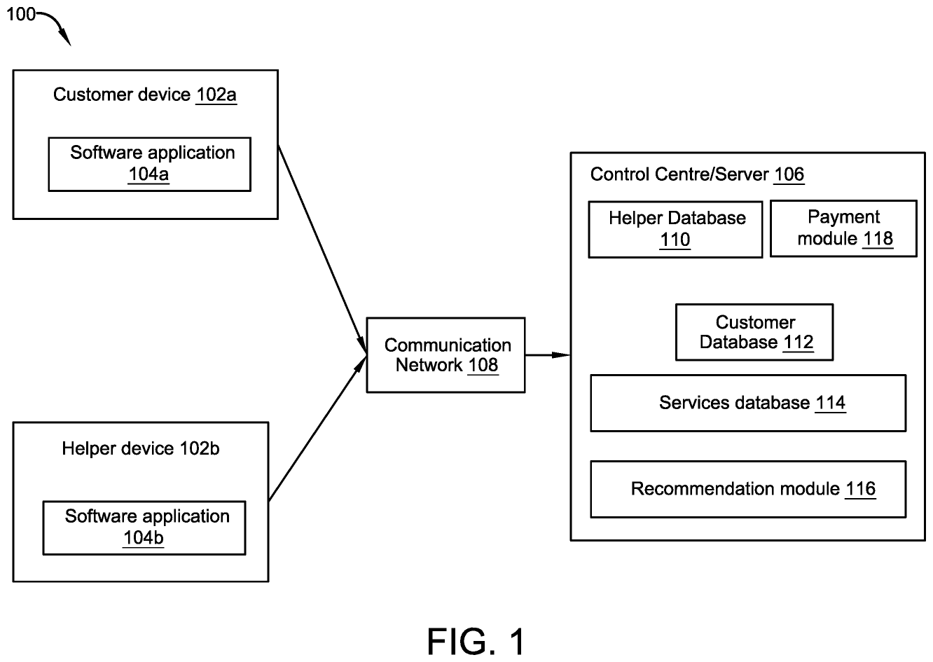

Referring initially to the drawings, FIG. 1 illustrates a schematic diagram of the on-demand service assistance system, the system 100 of the present invention is designed to enable customers to hire help for small and on-demand work such as cleaning a home, babysitting, cleaning, gardening, and more. The system 100 can be accessed including a diverse set of deployment alternatives, such as a service software application or a website. The offerings of the system 100 can also be integrated smoothly with pre-existing service websites/apps such as a ride-hailing service, resulting in a comprehensive platform adeptly catering to users' different support needs across a broad range of jobs and errands.

The system 100 which can also be marketed as “ride-hailing service helpers” provides a large, adaptable, and varied selection of gig, errand, work task, or service options for individuals to perform and customers to order using the system 100. The adaptable platform 100 can be used for a wide range of tasks, including but not limited to manual labor, precise errand choreography, and even the planning of elaborate installations, like the painstaking setting up (i.e., assembly) of fine dinner tables and many more. The system 100 enables setting of compensation terms within the application and giving users autonomy. The service facilitating system 100 provides an environment of fair compensation, also guaranteeing that the diligent efforts of hired assistants are compensated.

Multiple deployment possibilities can be supported by the inventively created architecture of the system 100. The system 100 can be accessed independently using a dedicated standalone mobile application, providing users with a unique interface designed for fluid task-driven interactions. As an alternative, the system 100 integrates smoothly into well-known service websites/apps, leveraging their already-existing user bases to improve accessibility and user convenience.

More specifically, the system 100 is accessed by customers and helpers or service providers. In the present disclosure, a customer is a person who orders a service using the system 100 and a helper is an individual who performs the ordered services. A customer accesses the system 100 using a client device 102A and a helper accesses the system using a helper device 102B. The devices 102A, 102B can be smartphones, laptops, smartwatches and more. The helper device 102B can be used by individuals eager to share their expertise and support, fostering a symbiotic ecosystem of cooperative support, while the customer device 102A ensures smooth interactions for users seeking assistance by offering a streamlined channel for articulating requirements and preferences. The customer device 102A has a customer version of software application 104a and the helper device 102B has helper version of the software application 104b. The application 104a provides user interfaces enabling a customer to easily order a service using the system 100 and the application 104b provides user interfaces for enabling a helper (i.e., service provider) to accept an order.

A communication network 108 serves as the link and effectively facilitates the interaction between these customer and helper devices by guaranteeing an unbroken flow of data exchange. A server or control center 106 provides the functionality offered by the system 100 for access by the applications 104a, 104b. The control center 106 serves as a central hub for system 100 functionalities, expertly directing the collaborative engagement. A plurality of databases and modules works together within the server 106 to guarantee the unhindered facilitation of the user's experience within the system 100. As illustrated, a number of databases and modules, including a helper database 110, a customer database 112, a services database 114, a recommendation module 116, and a payment module 118, are included in the control center 106. The control center 106 can be in the form of a cloud server, local server, distributed server, and the like. It will be apparent to a person skilled in the art that the server 106 provides a plurality of interfaces and functionality displayed in the applications 104a, 104b.

The helper database 110 is configured to store profiles of service providers or helpers registered in the system 100. The profile includes at least a name, gender, areas of expertise, availability, service cost, and more. The database 110 is used in the efficient selection of a helper for an order made by a customer. During sign up by a helper in the system, information received by the system 100 is stored in the helper database 110.

The server 106 includes a customer database 112 which is configured to store personal information and preferences of registered customers. The stored information includes name, gender, location, payment information, and more. The information is used for providing personalized recommendations and interactions to customers.

A services database 114 stores services included in the offerings of the system 100 and helps in streamlining the browsing and selection process for customers, thus accentuating user convenience. It will be apparent to a person skilled in the art the services can be added or deleted in real time from the database 114. Further, based on the regulations of a location, the services can also be deactivated for some of the locations.

Empowered by advanced algorithms, a recommendation module 116 of the server 106 provides optimal pairings between customers and service providers. This module significantly simplifies decision-making for users, ensuring that the suggested services harmonize seamlessly with their specific requirements. Depending on the profile and preferences of a user and expertise of a service provider, the recommendation module 116, using AI algorithms, suggests one or more service providers or helpers to the customer for selection. In some embodiments of the present invention, the recommendation module 116 automatically selects a helper for fulfilling an order of a customer. The recommendation module 116 also includes analysis of the ratings of helpers and proximity between the customer and helper for selection of the helper for a customer.

A payment module 118 which can be a third-party module 118 is configured to manage and process financial transactions between a customer and a helper. The payment module 118 enables customers to pay through different means such as credit cards, gift cards, and more enabling easy payment. It should be appreciated that the system 100 not only provides convenience to customers but also provides gigs to helpers while providing the trust of existing platforms such as ride-hailing services in some embodiments.

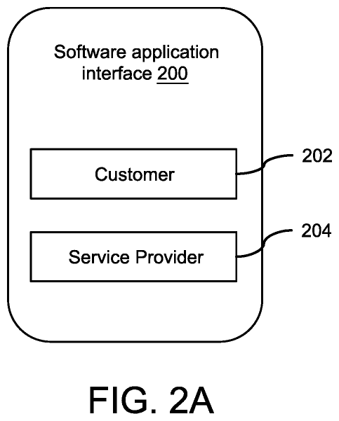

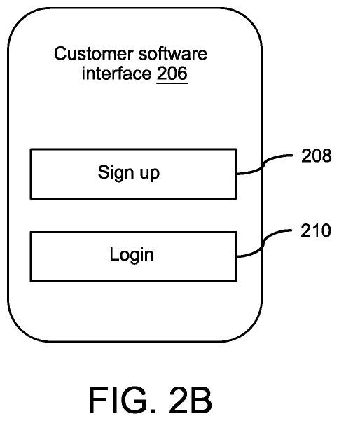

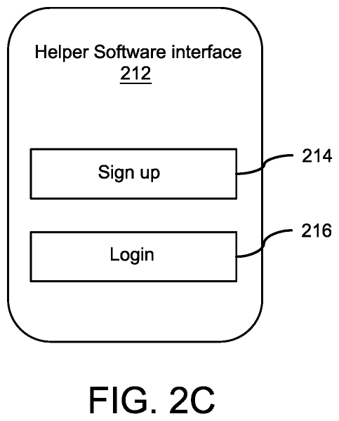

FIG. 2A illustrates an exemplary user interface 200 offered by the software application for user authentication within the system 100 in accordance with the disclosed architecture. The interface 200 provides a “customer or recipient” button 202 and the “helper or provider” button 204 for selection by a user. These buttons enable a user to access the application as a customer/recipient or a helper/provider and accordingly, the application displays user interfaces for accessing functionality offered by the system 100. Notably, pressing the “customer or recipient” button 202 sends users to a customer software interface 208 (shown in FIG. 2B) which is designed as per the customer demands and preferences. In addition, pressing the “helper or provider” button 204 provides access to the software interface for helpers (FIG. 2C).

Now referring to FIG. 2B, the user interface 206 offers customers options of joining or accessing the system 100 by prominently displaying a “sign up” button 208 and an adjacent “login” button 210. The “sign up” button 208 prompts users to enter necessary information for account creation and input personal information. These specifics usually include contact information, personal information, and other pertinent credentials, enabling for a thorough user profile construction which is stored in the customer database 112. The “login” button 210 enables users to quickly access their active accounts by requesting their registered email address or username and a strong password.

Similarly, FIG. 2C illustrates the helper interface 212 and displays a “sign up” button 214 and an adjacent “login” button 216. After pressing the “sign up” button 214, a helper can create their unique helper account. The details for making a helper profile encompass not only personal and contact information but also delve into the specialized skills and services that they intend to provide. The helpers can be given a list of services to choose from, including a broad range of options, including but not limited to childcare, carpentry, gardening, cleaning, laundry, and more. By entering their registered email address or username and a secure password when prompted by the “login” button in step 216 of the login process, helpers can access their accounts.

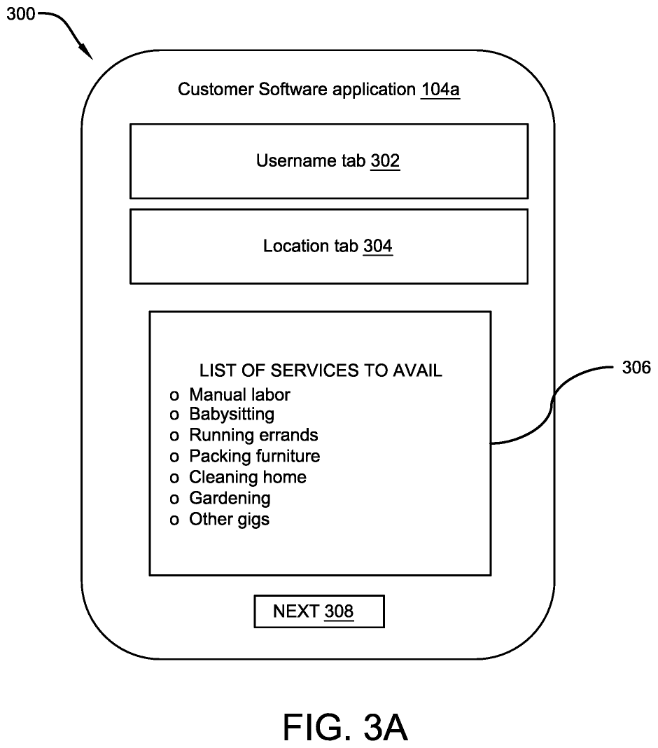

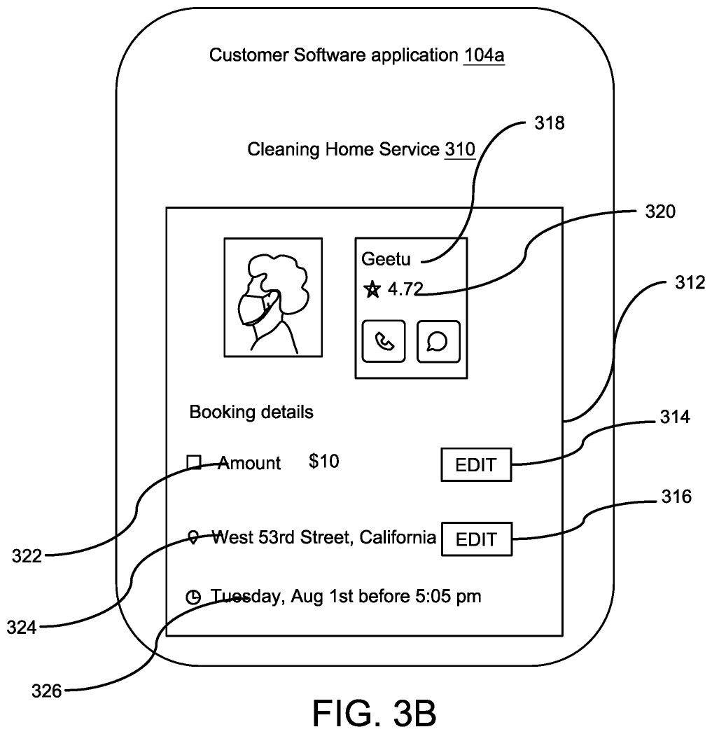

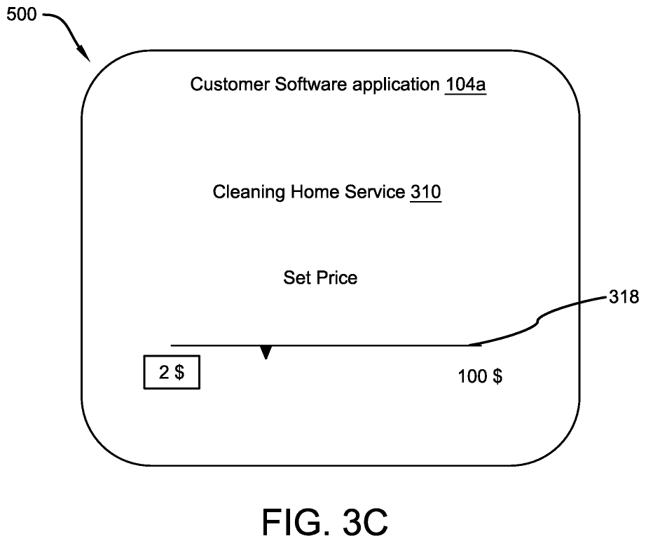

FIG. 3A illustrates an exemplary user interface 300 displayed by the software application 104a in accordance with the present embodiment. The interface 300 displays a user name tab 302, a location tab 304, a service list 306, and a next button 308. The user name tab 302 prominently exhibits the user's unique “user name” of the logged in customer. The location tab 304 displays real-time geolocation information of the customer. The location can be automatically detected using GPS sensor of the client device 102A or can be manually entered by the customer.

Furthermore, the service tab 306 displays a list of available services at the location of the customer. It should be appreciated that the customer can choose a service that aligns with their own requirements. The customer software interface 300 includes a “next” button 308. The next button 308 can enable the customer to pay for the chosen service or in some cases, can see a second page listing the available services. In some embodiments of the present invention, the list can be scrolled depending on the number of the services included in the list.

Now referring to FIG. 3B, another exemplary screen 400 of the customer software application 104a is shown. The interface 300 displays a selected service tab 310 and a booking details tab 312. The selected service tab 310 displays the name of the service chosen by the customer from the list of services displayed in FIG. 3A.

The booking tab 312 displays the “recommended helper” 319 and “helper rating” 320. The rating offers a tangible assessment of the helper's proficiency and dependability, offering details on their prior performance. The “service cost” 322 is the cost associated with the chosen service and is automatically calculated by the system 100. The tab 312 also displays the “service address” 324 of the location where the service is to be rendered by the helper. The “time and date of booking” 326 creates a temporal marker and solidifies the relationship.

An advantage of the present invention is that the consumer can change both service costs and location. Users can easily adjust service charges by using the edit button 314, and they can quickly change or update the designated location by pressing the edit button 316.

FIG. 3C illustrates an exemplary interface 500 for enabling a customer to adjust price in accordance with the current embodiment. When a customer clicks the “edit” button 314, a dynamic slider 318 mechanism that has been precisely tuned to enable simple alteration of service charges is unveiled. The slider fluidly moves across a wide range, enabling users to fine-tune pricing within a sensible range, for example in the range from $2 to $100.

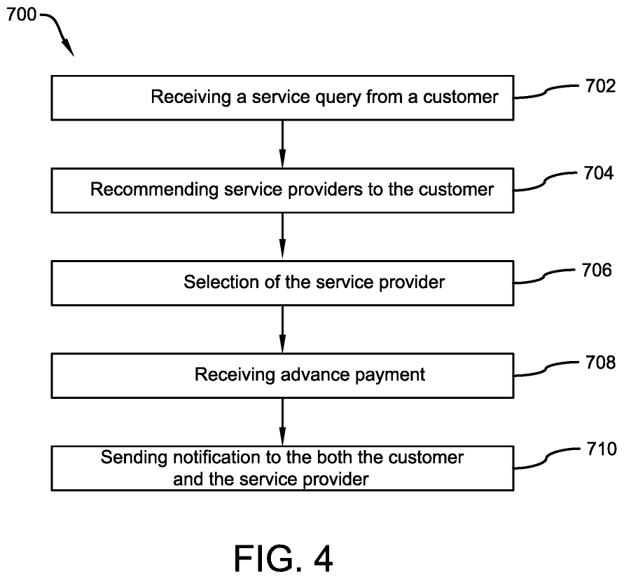

FIG. 4 illustrates a flow chart depicting a process of ordering a service by a customer using the service ordering system 100 of the present invention in accordance with the disclosed architecture. At step 702, the platform 100 receives a service query from a customer. The query may encapsulate the customer's service details for assistance, instigating the subsequent orchestration of activities.

At step 704, the ride-hailing service helper 100 based on the received request, profile of the customer, location of the service and more, provides a list of service providers or helpers for fulfilling the service. The recommendation module searches the helper database and customer database for providing a list of the helpers.

At step 706, the customer selects a desired service provider or helper from the displayed list. In some embodiments, the helper is automatically selected and hired for a job. The customer based on the selected helper can approve or even reject the service order.

At step 708, the ride-hailing service helper 100 platform initiates an advance payment process. The advance payment can be full payment or partial depending on the design of the system and preferences of the ordering customer.

At step 710, the platform 100 initiates notifications to both the discerning customer and the selected service provider. The notification can be in the form of a push notification, SMS, instant message, voice message, email and the like.

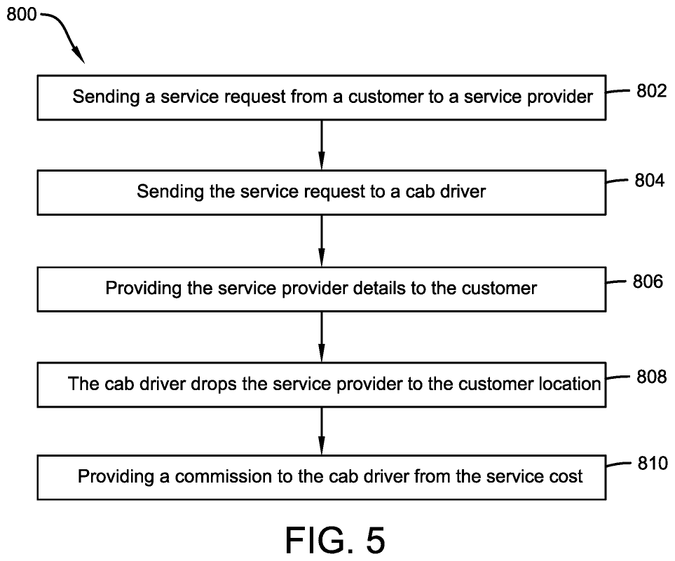

FIG. 5 illustrates a flowchart 800 outlining an alternative operational method within the ride-hailing service helper platform 100 in accordance with an embodiment of the present invention. Initially, at step 802, a service request from a customer is seamlessly conveyed to the selected service provider. The service provider can be selected as per the process depicted in FIG. 4 and the request may include details such as customer name, customer location, service charge, balance payment, and more.

At step 804, the platform 100 initiates a calibrated communication with a designated and authorized ride-hailing driver registered with the system 100. In the present embodiment, the ride-hailing driver drops the helper (i.e., service provider) to the customer location and thus, improves the authenticity of the process of the system.

At step 806, details of the selected service provider are provided to the customer along with an acceptance of service order by the selected service provider.

At step 808, the ride-hailing driver physically transports the service provider to the designated service location. This not only improves the trust but also ensures timeliness of the process. This is useful in the cases where an existing system such as a ride-hailing service implements the present invention for providing gigs to individuals to help their customers.

At step 810, whereby the service provider successfully concludes the service engagement at the customer's location. A commission is disbursed to the ride-hailing driver wherein the commission is derived from the service cost.

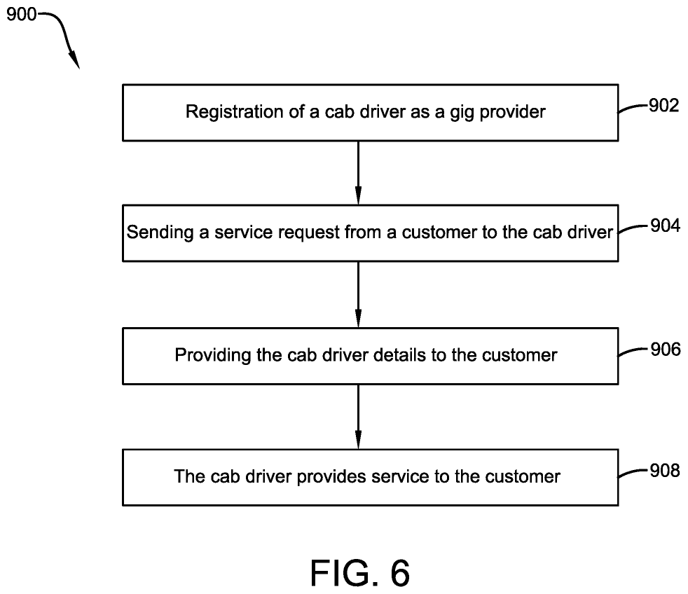

FIG. 6 illustrates a flowchart 900 depicting a process of performing a service by a ride-hailing driver registered in the system of the present invention in accordance with the disclosed architecture. At step 902, a ride-hailing driver registers as a gig or errand provider to offer one or more services to the customers of the system 100. It enables the existing service providers of a system to extend their offerings and earn revenue.

At step 904, a customer, seeking tailored assistance, initiates a service request and the platform sends the service request to the designated ride-hailing driver for servicing and processing.

At step 906, the ride-hailing driver details are provided to the customer for an effective service agreement between the customer and the ride-hailing driver.

A step 908, the ride-hailing driver, at designated location and time, provides service to the customer for completing a successful service order. It should be appreciated that an existing platform can earn revenue and improves customer satisfaction by providing such services using the present invention.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “on-demand service assistance system”, “services helper hire system”, “ride-hailing service helper system”, and “platform” are interchangeable and refer to the on-demand service assistance system 100 of the present invention.

Notwithstanding the forgoing, the on-demand service assistance system 100 and the software application 104a, 104b of the present invention can be of any suitable configuration as is known in the art without affecting the overall concept of the invention, provided that it accomplishes the above stated objectives. One of ordinary skill in the art will appreciate that the configuration and specification of the components of the on-demand service assistance system 100 and the software application 104a, 104b as shown are for illustrative purposes only, and that many other configurations of the on-demand service assistance system 100 and the software application 104a, 104b are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A service connecting system comprising:
a network of ride-hailing service providers offering services and a network of service recipients needing said services, wherein said services selected from a group consisting of a ride, a gig, an errand, and a work task;
wherein said service connecting system having a compensation term;
wherein said service connecting system having an application for access on an electronic device;
wherein said electronic device selected from a group consisting of a smartphone, a laptop, and a smartwatch; and
further wherein said network of said service connecting system including an existing network of said ride-hailing service providers offering said rides.

2. The service connecting system of claim 1, wherein said service recipients are customers of said service connecting system for ordering said services.

3. The service connecting system of claim 2, wherein said service providers provide said services including said ride and one or more of said gig, said errand, and said work task.

4. The service connecting system of claim 3, wherein said service connecting system having said services ordering interface for said service recipients.

5. The service connecting system of claim 4, wherein said service connecting system having said services accepting interface for said service providers.

6. The service connecting system of claim 5 further comprising a communication network linking said services ordering interface and said services accepting interface.

7. The service connecting system of claim 6, wherein said service connecting system having a plurality of databases selected from a group consisting of a service provider database, a service recipient database, and a services database.

8. The service connecting system of claim 7, wherein said service provider database having a profile of said service providers including information selected from a group consisting of a name, a gender, an area of expertise, an availability, and a service cost.

9. The service connecting system of claim 8, wherein said service recipient database having a profile of said service recipients including information selected from a group consisting of a name, a gender, a location, and a payment information.

10. The service connecting system of claim 9, wherein said services database having a stored listing of said services.

11. A service connecting system for connecting service providers with service recipients, the service connecting system comprising:
a network of service providers offering services and a network of service recipients needing said services, wherein said services selected from a group consisting of a ride, a gig, an errand, and a work task;
wherein said service connecting system having a compensation term and a payment module;
wherein said service connecting system having an application for access on an electronic device;
wherein said electronic device selected from a group consisting of a smartphone, a laptop, and a smartwatch;
wherein said network of service providers of said service connecting system including an existing network of ride-hailing providers offering said rides; and
further wherein said service recipients pay said compensation term of said services through said payment module to said service providers.

12. The service connecting system of claim 11, wherein said service provider is a said ride-hailing provider.

13. The service connecting system of claim 12, wherein said service providers provide said services including said ride and one or more of said gig, said errand, and said work task.

14. The service connecting system of claim 13, wherein said service connecting system having said services ordering interface for said service recipients.

15. The service connecting system of claim 14, wherein said service connecting system having said services accepting interface for said service providers.

16. The service connecting system of claim 15 further comprising a communication network linking said services ordering interface and said services accepting interface.

17. The service connecting system of claim 16, wherein said service connecting system having a plurality of databases selected from a group consisting of a service provider database, a service recipient database, and a services database, wherein said service provider database having a profile of said service providers including information selected from a group consisting of a name, a gender, an area of expertise, an availability, and a service cost, and further wherein said service recipient database having a profile of said service recipients including information selected from a group consisting of a name, a gender, a location, and a payment information.

18. A method of connecting service providers with service recipients, the method comprising the steps of:
providing a service connecting system having a network of service providers offering services and a network of service recipients needing said services, wherein said services selected from a group consisting of a ride, a gig, an errand, and a work task, further wherein said network of service providers including an existing network of ride-hailing providers offering said rides;
accessing said service connecting system through an application on an electronic device, wherein said electronic device selected from a group consisting of a smartphone, a laptop, and a smartwatch; and
paying for said service having a compensation term through a payment module of said service connecting system, wherein said service recipients pay said compensation term of said services through said payment module to said service providers.

19. The method of connecting service providers with service recipients of claim 18, wherein said service provider is a said ride-hailing provider.

20. The method of connecting service providers with service recipients of claim 19, wherein said service connecting system having a plurality of databases selected from a group consisting of a service provider database, a service recipient database, and a services database, wherein said service provider database having a profile of said service providers including information selected from a group consisting of a name, a gender, an area of expertise, an availability, and a service cost, and further wherein said service recipient database having a profile of said service recipients including information selected from a group consisting of a name, a gender, a location, and a payment information.
